(19) United States
(12) Patent Application Publication
(10) Pub. No.: US 2026/0227001 A1
(43) Pub. Date: Aug. 6, 2026

(54) GATE VALVE KEY ATTACHMENT TOOL

(71) Applicant: RAD Precision Inc, Bend, OR (US)

(72) Inventor: Anthony Edward DUCHON, Bend, OR (US)

(21) Appl. No.: 19/047,470

(22) Filed: Feb. 6, 2025

(51) Int. Cl. F16K 31/60

(52) U.S. Cl. CPC F16K 31/60

(57) ABSTRACT

A tool is disclosed. The tool includes a lock support member, a key male connection member that is coupled to the lock support member, and a nut coupling member that is coupled to the key male connection member. The nut coupling member includes an opening structured to receive a nut. The opening of the nut coupling member includes a plurality of tapered teeth extending along a majority of a height of the nut coupling member. The plurality of tapered teeth form a boundary for the opening. The plurality of tapered teeth taper inwardly towards a central axial axis of the tool. The plurality of tapered teeth are arranged in a rounded square-like pattern if viewed from a bottom-looking-up perspective of the tool.

### BACKGROUND

A “gate valve key” refers to a tool that is often used to manipulate a gate valve. Gate valves are typically used to control the flow of a substance, such as water or gas. A “gate valve key” can also be referred to as a “valve wheel wrench.”

FIG. 1 shows an example scenario involving a hydrant 100 that is supplied with water through a series of pipes, such as pipe 102. This pipe 102 might, in some instances, be a main line, which can be quite large (e.g., between about 10 inches in diameter to about 12 inches in diameter). Upstream of the hydrant 100 and connected to the pipe 102 is a gate valve 104 that is manipulable to control the flow of water streaming therethrough and to the hydrant 100, commercial, or residential property. In FIG. 1, the content illustrated using dashed lines is content that is under the ground. The burial depth of the pipe 102 and gate valve 104 can be set to any depth. Often, such depths range anywhere from approximately 6 inches to 12 feet, though sometimes even deeper. Often, the depth of the gate valve 104 is between 4 feet and 10 feet.

To reach the gate valve 104, a conventional tool called a gate valve key 106 is often used. The gate valve key 106 includes an elongated member 108 and a handle 110. The height of the elongated member 108 is often between about 6 inches to about 10 feet in height. In some cases, the handle 110 is omitted and a power tool connection member is provided. A power tool can be coupled to the power tool connection member to provide a rotational force so as to rotate the gate valve key 106 and the gate valve 104. Regardless of whether the handle 110 is used or the power tool connection member is used, by rotating the gate valve key 106 and the gate valve 104, the gate valve 104 will control the flow of water in the pipe 102.

In FIG. 1, notice also the x-y-z axis reference. The z-axis can be thought of as corresponding to the gravity vector relative to earth and can also be the axis reference used when describing the “height” of something. Typically, the z-axis is in the vertical direction. The x-axis and the y-axis are orthogonal to the z-axis.

FIGS. 2, 3, 4, and 5 illustrate further details regarding the gate valve key. In particular, FIG. 2 shows the gate valve key 106 from FIG. 1. The gate valve key 106 includes the elongated member 108, which has any height so as to accommodate different depths to reach the gate valve 104. The gate valve key 106 includes a space 112 or a central through hole (shown as being rectangular in shape in this example), and a key female connection member 114, which includes a key opening 116 that receives a nut. Stated differently, the key female connection member 114 couples to a nut portion (aka “nut” or “male nut connection member”) of the gate valve 104 via the key opening 116. In many scenarios, though certainly not all, the x-y dimensions of the nut are approximately 2 inches by 2 inches. FIG. 2 also shows a corresponding x-y-z axis for additional reference.

The space 112 is provided to allow mud, debris, and other buried ground substances that might be disposed on top of the nut to be pressed off of the nut when the gate valve key 106 is pressed onto the nut. For instance, suppose 1-2 inches of mud are disposed on top of the nut. If the space 112 was not provided, the mud would be compacted between the top portion of the key female connection member 114 and the nut, thereby leading to a less secure coupling between those two portions. By having the space 112, the mud can escape through the space 112 when the key female connection member 114 is pressed onto the nut, thereby leading to a more secure coupling.

FIG. 3 shows another perspective view of the gate valve key 106. FIG. 4 shows a sliced cross-sectional view of the gate valve key 106. Finally, FIG. 5 shows a bottom-looking-up perspective view of the gate valve key 106, and in particular the key opening 116. The gate valve key 106 is positioned over top of the nut, with the nut being inserted in the key opening 116. With reference to FIG. 4, the nut will pass through the key opening 116 and a portion of the nut will be surrounded by the key female connection member 114.

Regarding the gate valve 104, it is typically the case that the gate valve 104 is equipped with a square nut. This square nut is rotatable, and the rotation of the square nut modifies the internal position of the valve located within the gate valve 104, thereby controlling the flow of water in the pipe 102 to the hydrant 100. Thus, as shown in FIG. 5, the generalized shape of the key opening 116 is a square-like shape and corresponds to the shape of the nut on the gate valve 104. As mentioned previously, the nut is often 2″×2″. Consequently, the size of the key opening 116 is sufficient to be flush with the 2″×2″ nut. Of course, other sized gate valve keys can be employed, and this size is but one example.

With a traditional gate valve key 106, the fitment with the nut often becomes quite loose due to various reasons. For example, due to potential differences in metal hardness properties as between the nut and the gate valve key 106, the square-like shape of the nut will often become rounded throughout use. The square-like shape will strip over time and will approach that of a circle, or at least a severely rounded square. Also, gate valves are often buried in the ground for multiple decades, and repeated torquing via the gate valve key 106 will round the corners of the nut. Additionally, the nut is often made of cast iron. Because the nut is buried under the ground, corrosion and other deterioration (e.g., oxidation and rusting) to the iron will progressively occur over time, leading to further deformities of the nut and complications when the nut is coupled to the gate valve key 106. In any event, the modified, or rather deformed, shape often causes operators using the gate valve key 106 severe challenges in manipulating the gate valve 104.

It should also be noted that the amount of torque needed to manipulate the gate valve 104 might be quite large depending on the size of the pipe 102 and the gate valve 104. For instance, if the pipe 102 is a main line (e.g., 10-12 inches), a large torque will likely be required to manipulate the gate valve 104, especially if that gate valve 104 has been in place for multiple decades and if it operates at high pressure. Applying large amounts of torque further contributes to the degradation in the shape of the nut.

In view of the above issues, what is needed is an improved tool that solves the challenges that arise when the shape of a gate valve nut has been deformed. It is desirable to use an improved tool that is structured in such a way so as to accommodate any condition of a nut, regardless of whether it is a new nut or is a degraded nut.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a tool that operates as an attachment to a gate valve key, said tool including: a lock support member including a lock pin hole through which a lock pin is placeable to secure the tool to the gate valve key, the lock support member being coupled to a key male connection member, the key male connection member, which has a first form approximating that of a first rectangular prism, the key male connection member being coupled to a nut coupling member; and the nut coupling member, which has a second form approximating that of a second rectangular prism, wherein: a first width of the key male connection member is smaller than a second width of the nut coupling member, resulting in a step being formed at a location where the key male connection member couples to the nut coupling member, the nut coupling member includes an opening structured to receive a nut, the opening of the nut coupling member includes a plurality of tapered teeth extending along a majority of a height of the nut coupling member, the plurality of tapered teeth tapering inwardly towards a central axial axis of the tool, and the plurality of tapered teeth form a boundary for the opening and are arranged in a rounded square-like pattern if viewed from a bottom-looking-up perspective of the tool.

In some aspects, the techniques described herein relate to a tool that operates as an attachment to a gate valve key, said tool including: a lock support member structured to facilitate coupling of the tool to the gate valve key, the lock support member being coupled to a key male connection member, wherein the lock support member has a first form approximating that of a first rectangular prism; the key male connection member, which has a second form approximating that of a second rectangular prism, the key male connection member being coupled to a nut coupling member; and the nut coupling member, which has a third form approximating that of a third rectangular prism, wherein: a first width of the lock support member is smaller than a second width of the key male connection member, resulting in a first step being formed at a first location where the lock support member couples to the key male connection member, the second width of the key male connection member is smaller than a third width of the nut coupling member, resulting in a second step being formed at a location where the key male connection member couples to the nut coupling member, the nut coupling member includes an opening structured to receive a nut; the opening of the nut coupling member includes a plurality of tapered teeth extending along a majority of a height of the nut coupling member, the plurality of tapered teeth tapering inwardly towards a central axial axis of the tool, and the plurality of tapered teeth form a boundary for the opening and are arranged in a rounded square-like pattern if viewed from a bottom-looking-up perspective of the tool.

In some aspects, the techniques described herein relate to a tool including: a lock support member; a key male connection member that is coupled to the lock support member; and a nut coupling member that is coupled to the key male connection member, wherein: the nut coupling member includes an opening structured to receive a nut; the opening of the nut coupling member includes a plurality of tapered teeth extending along a majority of a height of the nut coupling member, the plurality of tapered teeth form a boundary for the opening, the plurality of tapered teeth taper inwardly towards a central axial axis of the tool, and the plurality of tapered teeth are arranged in a rounded square-like pattern if viewed from a bottom-looking-up perspective of the tool.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example scenario where a gate valve key is being used to turn a gate valve.

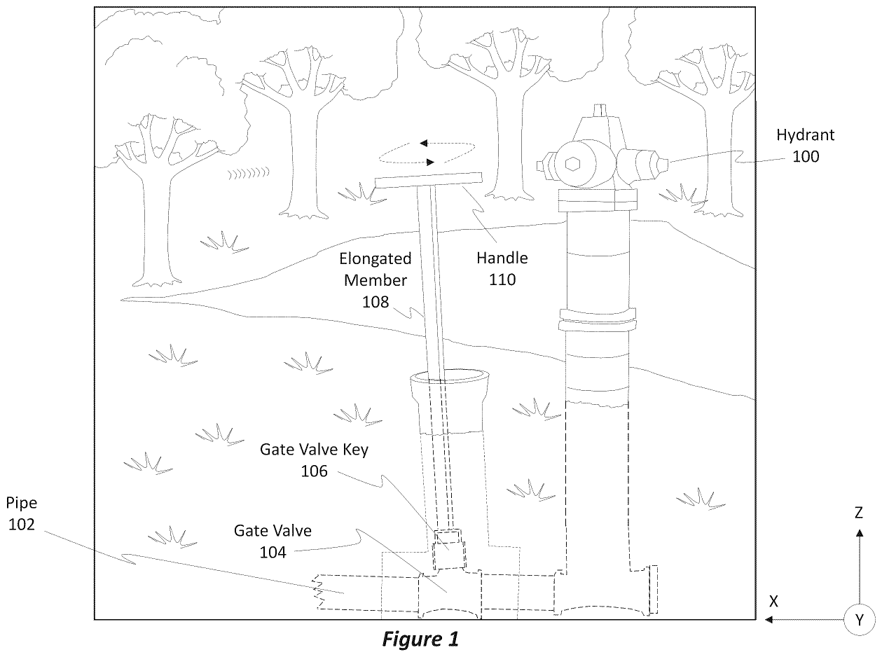

FIGS. 2, 3, 4, and 5 illustrate various different perspective views of a gate valve key.

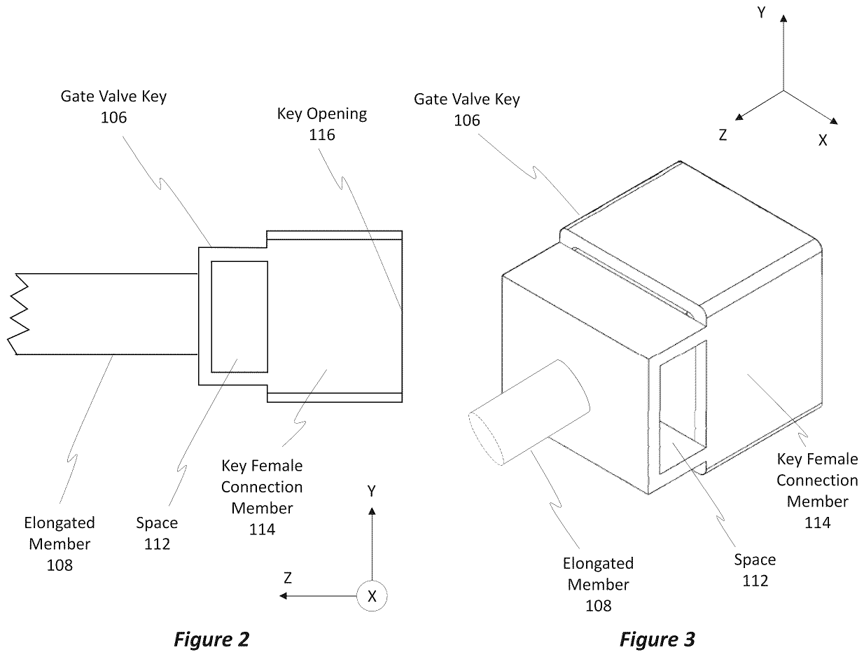

FIG. 6 illustrates an example of a tool that can be attached to a gate valve key to enhance the operability of the gate valve key.

FIG. 7 illustrates a cross-sectional view of the tool and the gate valve key.

FIG. 8 illustrates another cross-sectional view of the tool and the gate valve key.

FIG. 9 illustrates a side perspective view of the tool as it is fit within the gate valve key.

FIG. 10 illustrates an angled view of the tool.

FIGS. 11, 12, 13, and 14 illustrate different side views of the tool.

FIG. 15 illustrates a top side perspective view of the tool.

FIG. 16 illustrates a bottom side perspective view of the tool.

FIG. 17 illustrates an angled view of the tool.

FIG. 18 illustrates another angled view of the tool.

FIG. 19 illustrates another angled view of the tool.

FIG. 20 illustrates another angled view of the tool.

FIG. 21 illustrates another angled cross-sectional view of the tool.

### DETAILED DESCRIPTION

The embodiments disclosed herein are directed to an improved tool that solves the challenges that arise when the shape of a gate valve nut has been deformed. This improved tool is structured in such a way so as to accommodate any condition of a nut, regardless of whether it is a new nut or is a degraded nut. The improved tool can optionally be designed to operate in conjunction with existing gate valve keys, such as by operating as an attachment to an existing gate valve key, or it can operate as a standalone unit. For instance, the tool can be equipped with its own elongated member and corresponding handle. Thus, in some embodiments, the tool is an attachment that can be securely and physically coupled to an existing gate valve key while in other embodiments, the tool is a standalone unit that includes its own elongated member and handle. Regardless of whether the tool is implemented as an attachment or a standalone unit, the tool is designed in such a way so as to eliminate or substantially mitigate the challenges that arise when a nut has been deformed.

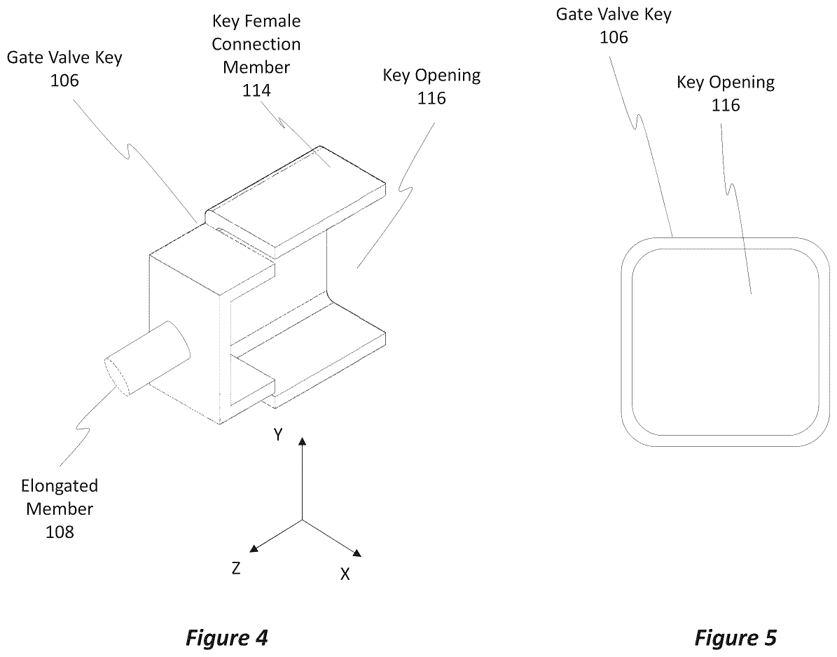

Attention will now be directed to FIG. 6, which again shows the gate valve key 106, which includes the elongated member 108, the space 112, and the key female connection member 114. Under traditional scenarios, the nut of the gate valve 104 would be positioned inside of the key female connection member 114. Now, however, a new tool 118 is used to enhance the abilities of the gate valve key 106 so as to accommodate nuts that have degraded. In the example shown in FIG. 6, the tool 118 is an attachment that is attached to the gate valve key 106. In other embodiments, however, the tool 118 can be a standalone tool and may include its own elongated member and corresponding handle. FIG. 6 also shows an x-y-z legend, which has a similar orientation or set of reference points as the earlier x-y-z legends.

Tool 118 is shown as including a lock support member 120, a key male connection member 122, a nut coupling member 124, and a lock pin hole 126A. Further details on each of these features will now be provided.

The lock support member 120 and the key male connection member 122 are structured and sized so as to be insertable into the key female connection member 114 of an existing gate valve key 106.

In some embodiments, the shape of the lock support member 120 approximates that of a first rectangular prism. The shape of the key male connection member 122 approximates that of a second rectangular prism. The shape of the nut coupling member 124 approximates that of a third rectangular prism.

The key male connection member 122 has dimensions similar to that of a gate valve nut. One example set of dimensions is 2″ (length)×2″ (width). The dimensions of the lock support member 120 are smaller than the dimensions of the key male connection member 122, and the lock support member 120 is sized so as to fit within the region defined by the space 112. Further examples of dimensional values will be provided later.

When the tool 118 is inserted into the gate valve key 106, the lock pin hole 126A will be visible through the space 112. A lock pin can inserted through one side of the space 112, through the lock pin hole 126A, and through the other side of the space 112. The lock pin can thus secure the tool 118 to the gate valve key 106.

As another description, the key male connection member 122 can be viewed as being a mating flange for the tool 118. The dimensions of the mating flange correspond to the dimensions of the key female connection member 114, though the dimensions are somewhat smaller, similar to that of a gate valve nut.

The fastening procedure is intuitive. That is, through the use of the lock pin, the tool 118 can be securely fastened to the gate valve key 106. Recall, gate valve keys come in varying heights. Through this intuitive fastening procedure, the tool 118 can be easily fastened or coupled to different gate valve keys in a quick and easy manner. Thus, depending on the depth where the gate valve 104 is located, the operator will obtain a gate valve key that is suitably long to accommodate the depth. The tool 118 can then be quickly affixed to the gate valve key.

Stated differently, the lock pin and the lock pin hole 126A are structured to ensure that the tool 118 is not axially (e.g., along the z-axis direction) dislodged or removed from the gate valve key 106. With reference to FIG. 6, if the z-direction where parallel to the gravity vector, then the lock pin positioned through the space 112 and the lock pin hole 126A would prevent the tool 118 from falling out of the gate valve key 106.

As will be discussed in more detail later, the nut coupling member 124 includes a set of features that enable the tool 118 to better secure itself to a gate valve nut. These features are specially designed to couple the tool 118 to the nut, regardless of the deteriorated state of the nut.

Recall, a torque or rotational force is transmitted from the handle 110 through the elongated member 108 to the end of the gate valve key 106. Traditionally, a nut is disposed within the key female connection member 114, and the torque is applied to the nut. Now, however, with the key male connection member 122 being inserted into the key female connection member 114, the torque is transmitted from the key female connection member 114 to the key male connection member 122 and then transmitted to the nut coupling member 124. A nut will be disposed within the nut coupling member 124, so the torque is applied to the nut.

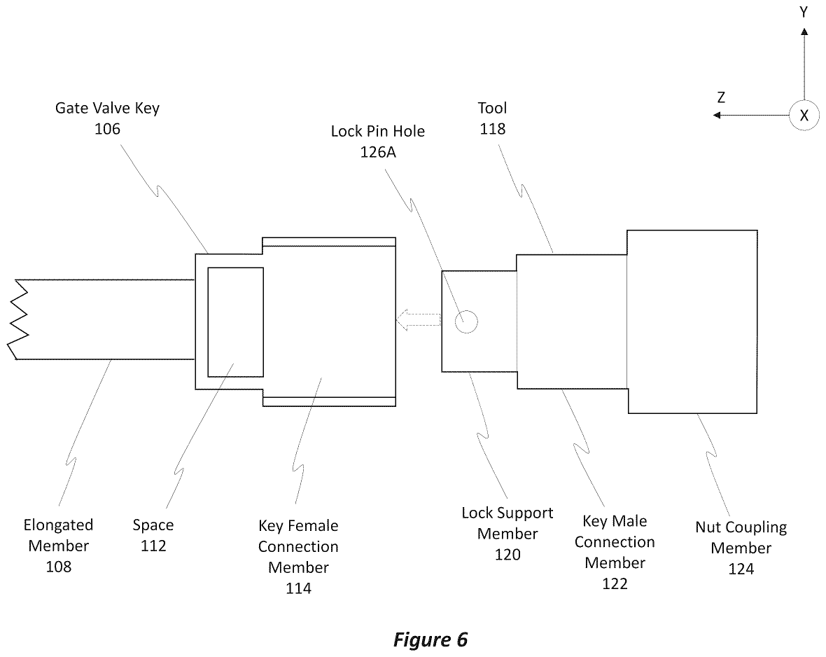

FIG. 7 shows a cross-sectional view of the gate valve key 106 with the tool 118 fully disposed within the gate valve key 106. Whereas previously, only a single lock pin hole 126A was visible on the tool 118, now a second lock pin hole 126B is visible. Subsequent figures will show how additional lock pin holes (e.g., up to four in total) can also be included in the tool 118.

FIG. 7 shows how a lock pin can be inserted through the space 112, through the lock pin hole 126B, through the lock pin hole 126A, and then through the opposite side of the space 112. The lock support member 120 is at least partially visible through the space 112.

One can also observe how the key male connection member 122 is inserted into the recess formed by the key female connection member 114. Traditionally, a gate valve nut would be disposed in this recess. Now, however, the tool 118, and in particular the key male connection member 122, is disposed in the recess formed by the key female connection member 114. Notice also, the tolerance between the key male connection member 122 and the key female connection member 114 is sufficient to allow the key male connection member 122 to be fully insertable into the key female connection member 114 while still providing a secure fit between the two members.

Turning briefly back to FIG. 6, notice the step-like progression between the left-most end (relative to FIG. 6) of the tool 118 and the right-most end of the tool 118. The y-axis dimension of the lock support member 120 is a first size, the y-axis dimension of the key male connection member 122 is a second size, and the y-axis dimension of the nut coupling member 124 is a third size. The first size is smaller than the second size, and the second size is smaller than the third size, resulting in a step-like progression in width of the tool 118.

Regarding the dimensions, example dimensions will be provided later. Generally, the width and length of the key male connection member 122 approximates that of a gate valve nut, which is approximately 2″ (length)×2″ (width).

Returning to FIG. 7, notice the step formed due to the difference is size between the key male connection member 122 and the nut coupling member 124. This step operates as a stopping mechanism for the tool 118. This stopping mechanism or step enables the end of the key female connection member 114 (of the gate valve key 106) to abut the step, thereby leading to even greater coupling between the two units.

FIG. 7 also shows an opening 128 at the bottom end (e.g., in the z-axis direction) of the nut coupling member 124. Within this opening 128 and positioned at the boundary region of the opening 128 are a set of teeth 130. These teeth 130 are structured in a manner so as to provide improved gripping with respect to a nut. Further details on these teeth 130 will be provided later.

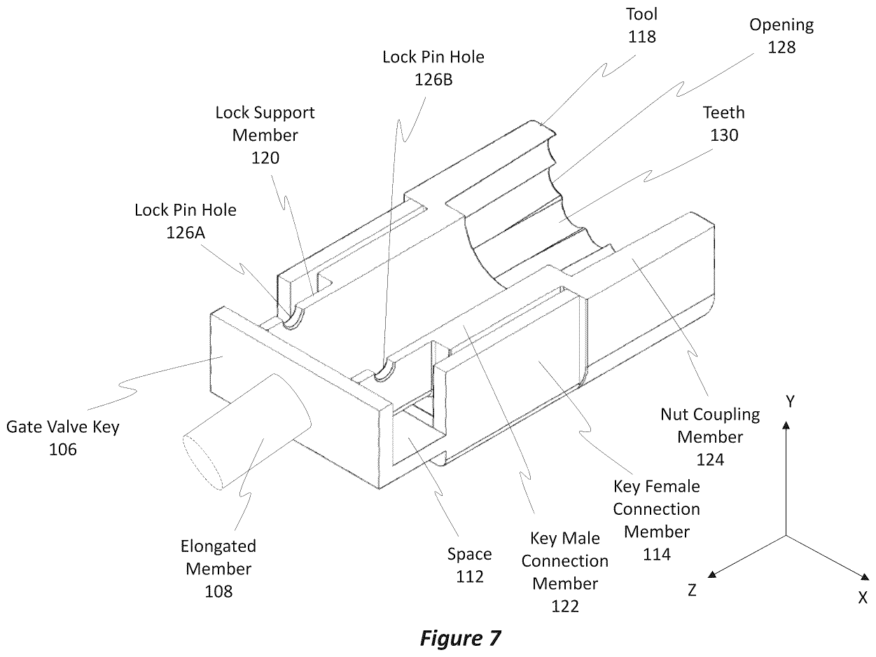

FIG. 8 shows another cross-sectional view of the gate valve key 106 and the tool 118, as it is partially removed from the gate valve key 106. The dashed arrow signifies how the tool 118 can be further inserted into the gate valve key 106. FIG. 8 also shows the opening 128 at the bottom portion of the nut coupling member 124 and the teeth 130.

Regarding the teeth 130, notice in FIG. 8 how the teeth 130 are designed in such a manner so that the teeth are angled, inclined, or tapered relative to the z-axis. For instance, consider the left-most (relative to FIG. 8) tooth 130A. Tooth 130A is shown as not being perpendicular to the z-axis; instead, tooth 130A has a slight angle or taper relative to the z-axis. In this scenario, if the bottom of the opening 128 corresponded to a 0 degree angle and if the z-axis corresponded to a 90 degree angle, the angle of the tooth 130A is approximately 88 degrees. Stated differently, in this example, the tapering is approximately 2 degrees.

The angling or tapering of the teeth 130 can be set to any angle. Often, the angle is within a range of angles spanning from about 60 degrees to about 89 degrees. In some cases, the range is smaller, such as from about 80 degrees to about 89 degrees. Any angle value between about 60 degrees and 89 degrees can be used. Thus, in terms of the incline or tapering, the tapering angle is often some value within a range spanning from about 1 degree to about 40 degrees (angled inward toward the central axis of tool 118). Often, the range is smaller, such as between 1 degree and 5 degrees. In some scenarios, the tapering value is approximately 2 degrees. The tapering angle is provided to allow the tool 118 to self-adapt to the deformities that may be present on the nut. The angle is sufficient to allow the tool 118 to grip onto the nut while not being so extreme that is causes the nut to naturally push out of the tool 118.

Returning briefly to FIG. 7, notice the teeth 130 are formed using a series of cylindrical cut outs from the nut coupling member 124. For instance, in FIG. 7, the combination of cylindrical cut out forms a series of teeth that can grip a nut.

In FIG. 8, the cylindrical cut outs are also visible. FIG. 8 also shows how these cylindrical cut outs are angled, as mentioned above. In some scenarios, the manufacture of these teeth 130 is relatively straightforward in that an angle drill bit can be used to drill out each cylindrical cut out. Later figures will better illustrate the properties of the teeth 130. In any event, however, a nut can be inserted into the opening 128. Due to the gripping and angled properties of the teeth 130, the nut will catch on the teeth 130 even if the nut is deformed or corroded in some manner. Again, further details will be provided later.

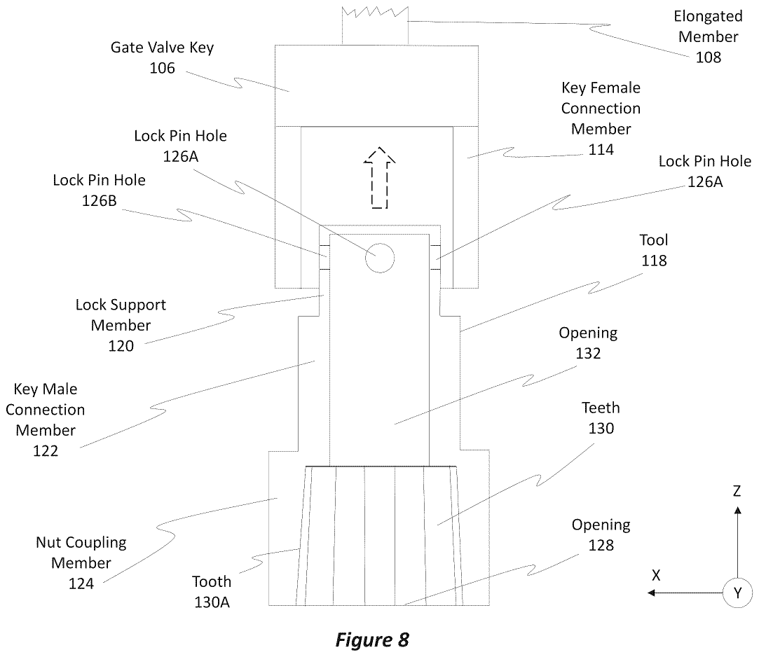

FIG. 9 shows a side perspective view of the gate valve key 106 with the tool 118 fully inserted into the gate valve key 106. Notice, the space 112 is visible. Through that space 112, one can observe the lock support member 120 of the tool 118 as well as the lock pin hole 126A. The key female connection member 114 of the gate valve key 106 is visible. Although not currently visible, the key male connection member 122 of the tool 118 is disposed in the recess formed by the key female connection member 114.

The nut coupling member 124 of the tool 118 is visible, however. The gate valve nut will be disposed within the opening 128 (not shown in FIG. 9) of the nut coupling member 124.

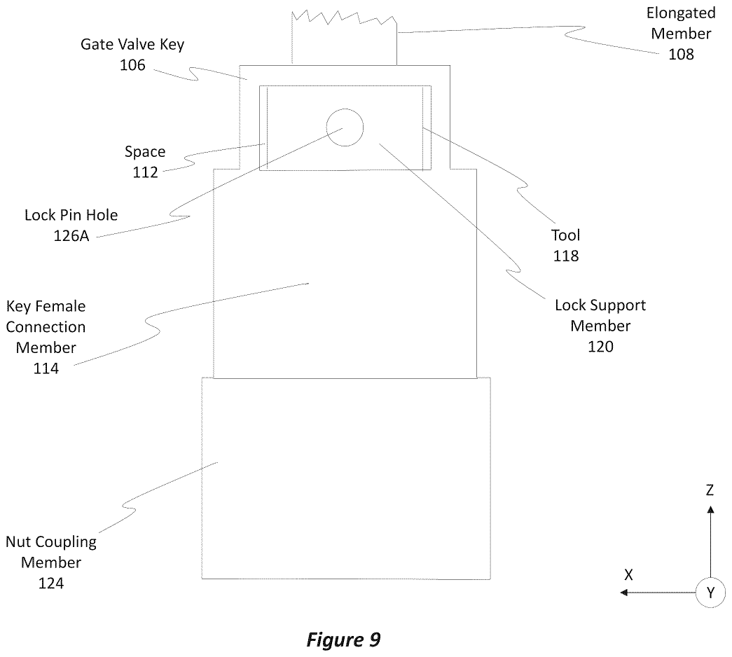

FIG. 10 shows an angled perspective view of the tool 118. The gate valve key 106 is not shown in FIG. 10.

From the perspective shown in FIG. 10, one can now observe all four lock pin holes, such as lock pin hole 126A, lock pin hole 126B, lock pin hole 126C, and lock pin hole 126D. From this perspective, one can also observe an opening 132. Opening 132 is a recess having the shape of a cylinder. That is, a cylindrical cut out forms the opening 132.

Opening 132 extends throughout the entire height of the lock support member 120 and further extends throughout the entire height of the key male connection member 122. As will be visible in a later figure, if the tool 118 were observed from a bottom perspective, the opening 132 would also be visible at the top-most portion of the nut coupling member 124. Thus, the axial central region (e.g., parallel to the z-axis) is hollow, and a portion of that hollow region is cylindrical in shape, as shown by the opening 132.

As mentioned previously, the space 112 in the gate valve key 106 is provided to allow mud and other buried ground substances that might be disposed on top of the nut to be pressed off of the nut when the gate valve key 106 is coupled to the nut portion. The opening 132 provides a similar function to the space 112. For instance, if mud or debris is located on top of the nut during placement of the tool 118, the mud can be pressed through the cavity formed by opening 132. From there, the mud can escape through the space 112. Thus, opening 132 provides similar functionality as the space 112, and the opening 132 and the space 112 can work together to allow debris to be removed from the top of the nut.

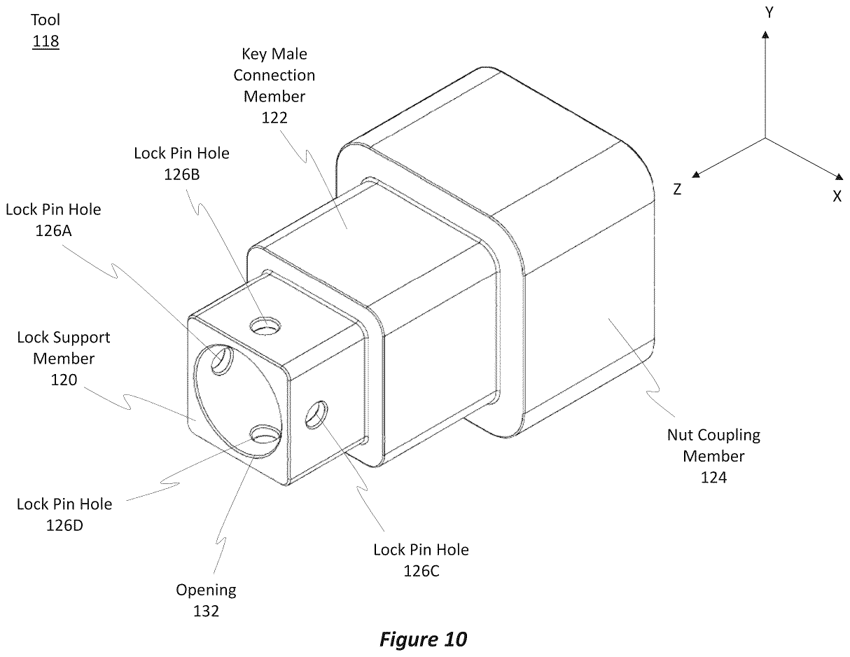

FIG. 11 shows a first side perspective 134 of the tool 118. FIG. 12 shows a second side perspective 136 of the tool 118. FIG. 13 shows a third side perspective 138 of the tool 118. FIG. 14 shows a fourth side perspective 140 of the tool 118. Thus, the four different sides of the tool 118 are shown in FIGS. 11 through 14.

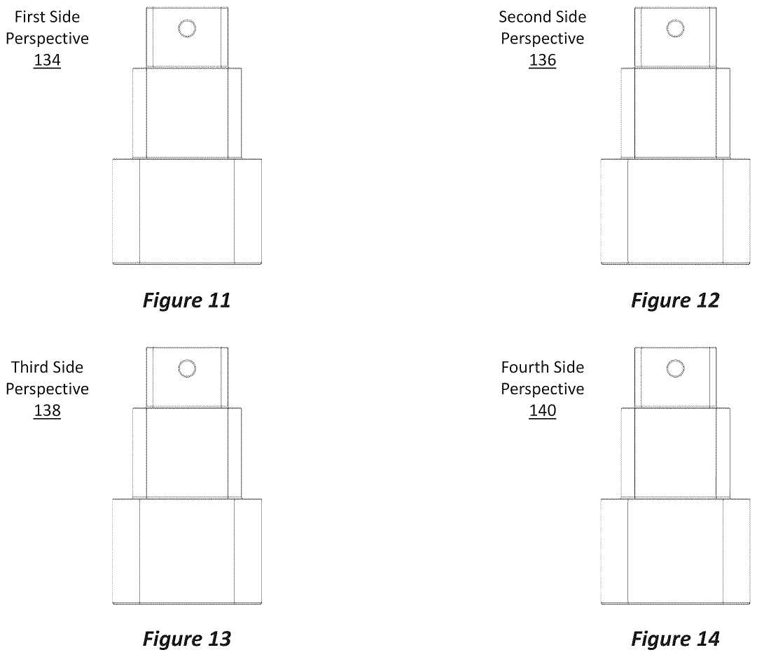

FIG. 15 shows a top side perspective 142 (i.e. an aerial view) of the tool 118. The opening 132 is visible and runs through the height of the tool 118, as shown by the opening 132 illustrated in FIG. 8 in which the opening 132 extends from the very topmost portion of tool 118 to at least the nut coupling member 124. In FIG. 15, from this perspective, one can also observe the steps of the tool 118. For instance, a first, relatively smaller step is formed by the lock support member 120. A second, medium sized step is formed by the key male connection member 122. A third, large sized step is formed by the nut coupling member 124.

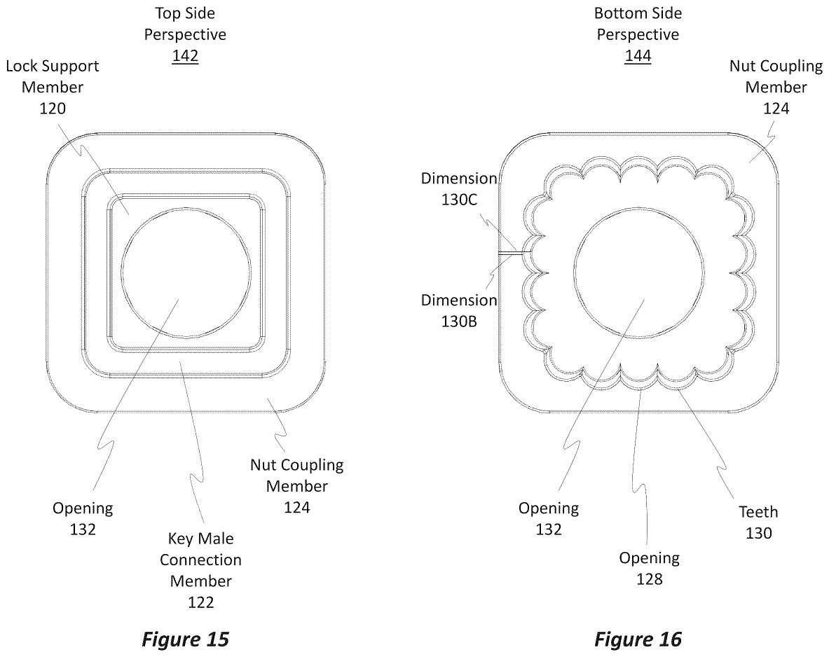

FIG. 16 shows a bottom side perspective 144 of the tool 118. From this perspective, the opening 132 is visible. The opening 132 connects with a cavity formed within the nut coupling member 124, where this cavity is the opening 128 in FIG. 16. The outer boundary of the opening 128 includes the teeth 130.

From the perspective shown in FIG. 16, one can also observe the angling aspect or tapering of the teeth 130. For instance, at the outermost part of opening 128 (i.e. the very bottom of the tool 118), the teeth 130 are at positions that are closest to the outermost perimeter of the nut coupling member 124, as shown by dimension 130B. As the height of the teeth 130 increases (e.g., in the z-axis direction), the teeth 130 progressively became farther removed from the outer perimeter of the nut coupling member 124, as shown by dimension 130C. To be clear, dimension 130C is larger than dimension 130B, indicating how the teeth 130 start closer to the outer perimeter of the nut coupling member 124 but progressively become farther removed from that outer perimeter in a tapered manner. Thus, using FIG. 8 as a reference, the top part of tooth 130A (i.e. the part closer to the key male connection member 122) is farther from the outer perimeter of the nut coupling member 124 as compared to the bottom part of tooth 130A (i.e. the part closer to the opening 128).

FIG. 16 also shows the cylindrical cut outs that form the teeth 130. In this example illustration, there are 18 cylindrical cut outs, the combination of which are generally shaped as a square. A person skilled in the art will appreciate how the diameter of the cylindrical cut outs will determine the number of teeth 130. Larger cylindrical cut outs will result in fewer teeth 130 while smaller cylindrical cut outs will result in more teeth 130. Thus, it will be appreciated how the number can vary.

Often, the number of cylindrical cut outs (i.e. teeth) is a value within a range spanning from about 10 teeth to about 50 teeth, though more than 50 can be present. In the scenario where 18 teeth are present, the diameter for the circle forming each tooth is 0.4.″ Of course, larger or smaller teeth can be used.

In most scenarios, the diameter of each teeth is uniform. In rare scenarios, the diameters of the teeth might vary. For instance, some teeth might have a first diameter, other teeth might have a second diameter, and yet other teeth might have a third diameter. One possible scenario involving differently sized teeth is one where the rounded corners of the square-like shape have teeth of a first size and the longer stretches between the rounded corners have teeth of a second size. This configuration can be particularly beneficially in scenarios where the corners of the nut have severely degraded, and an increased number of teeth at the rounded corner regions can facilitate improved gripping.

These teeth 130 include two sharp terminal ends and a curved or concave portion therebetween. One tooth immediately abuts another tooth. As mentioned above, the combination of teeth 130 are designed to approximate a square, which also approximates the shape of a gate valve nut. Even when a gate valve nut has deteriorated, the sharp terminal ends of the teeth 130 and the angled aspect of the teeth 130 will enable the teeth 130 to securely grip the deformed nut.

In some embodiments, the teeth are not only tapered but are also curved along the z-height of the teeth. In effect, the teeth are structured to have a spiral like configuration along the z-axis (i.e. along the height of the nut coupling member 124). This spiraling configuration can further improve the gripping aspects of tool 118 onto the nut.

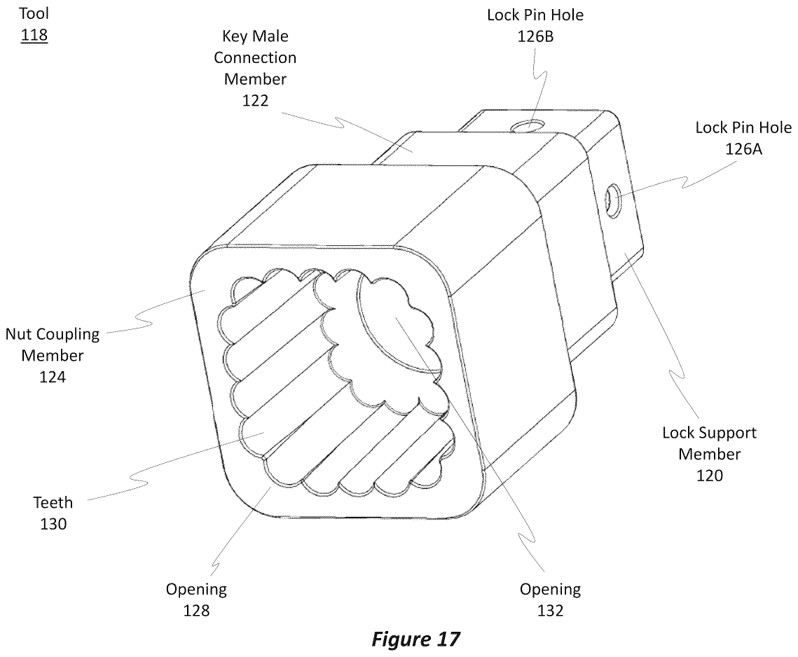

FIG. 17 shows another angled perspective view (from the bottom looking up) of tool 118. Lock pin holes 126A and 126B are visible from this perspective. Also, the bottom portion of the opening 132 is visible from this angle. The opening 128 of the nut coupling member 124 is visible as well as the teeth 130.

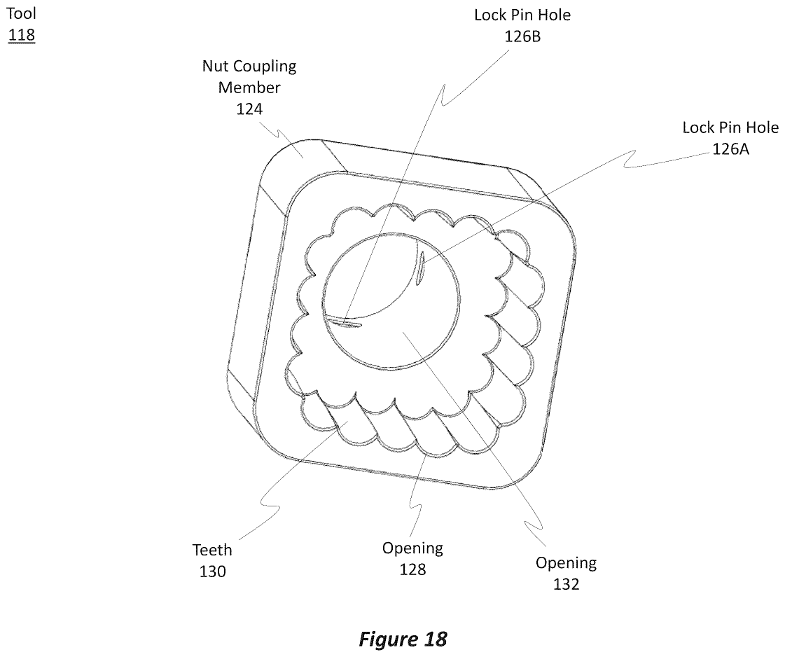

FIG. 18 shows another angled view of the tool 118, again from the bottom looking up. Here, the lock pin holes 126A and 126B are visible, as well as the opening 132, the opening 128, and the teeth 130. It should be noted how the height of the teeth 130 extend through a substantial majority of the height of the nut coupling member 124. Typically, the height of the teeth 130 is at least 90% of the height of the nut coupling member 124. Sometimes, the height of the teeth 130 is more than about 95% of the height of the nut coupling member 124. This percentage relationship is particularly illustrated in FIG. 8, where the height of the teeth 130 (e.g., in the z-axis direction) is more than 90% of the height of the nut coupling member 124.

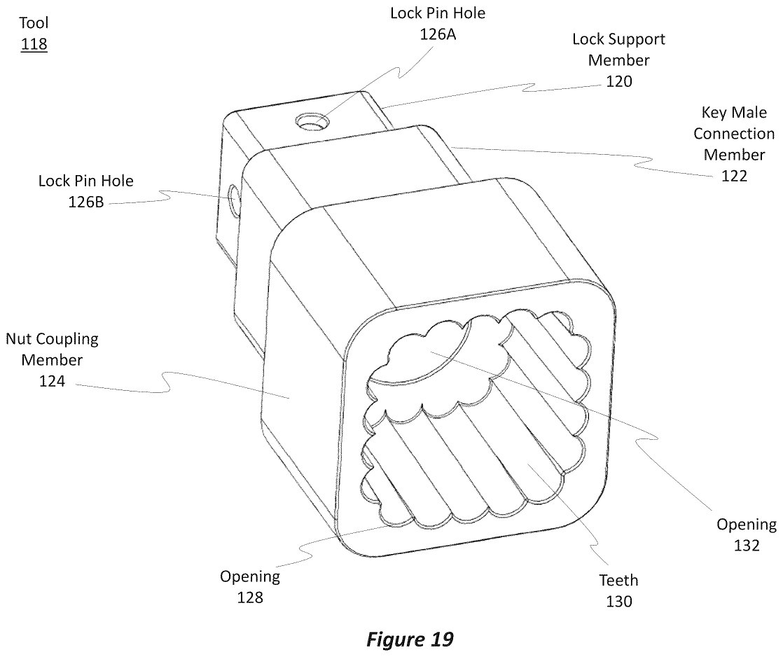

FIG. 19 shows yet another perspective view of the tool 118. From this perspective, the lock pin holes 126A and 126B are visible, along with the opening 132, the opening 128, and the teeth 130.

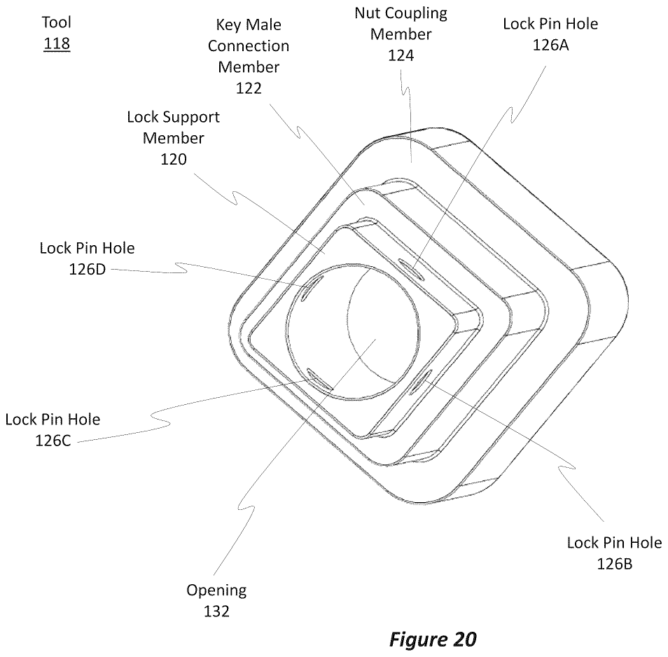

FIG. 20 shows another perspective view from the top. Here, the opening 132 is visible, along with the lock pin holes 126A, 126B, 126C, and 126D. Although four lock pin holes are shown, some embodiments include a different number of lock pin holes. For instance, some embodiments include only two lock pin holes located on opposing sides of the lock support member 120.

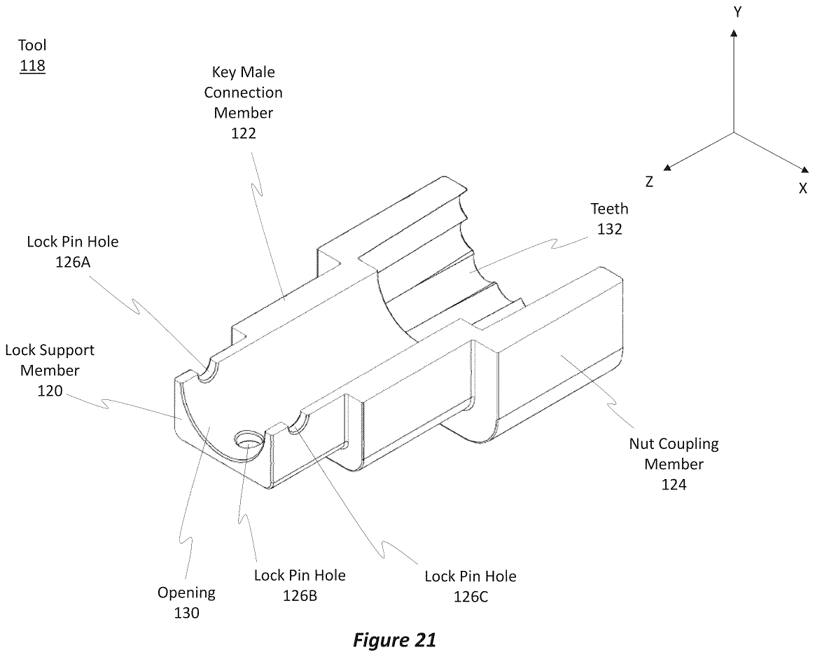

Finally, FIG. 21 shows a cross-sectional view of the tool 118. From this vantage, one can observe the lock pin holes 126A, 126B, and 126C. The opening 132 is also visible as well as the teeth 130.

Although a majority of the examples recited herein focused on a scenario involving a nut having a 2″×2″ dimension and involving a tool 118 and gate valve key 106 having corresponding dimensions, a person skilled in the art will appreciate how any dimension can be used. For instance, smaller dimensions and larger dimensions can also be used. The embodiments can be implemented in the form of a socket, and the dimensions of traditional sockets (e.g., both in SAE and metric) can be employed, without limit. Thus, in some scenarios, the disclosed embodiments can be implemented in the form of an attachment to a traditional socket.

In the scenario shown in FIG. 6, the height (e.g., in the z-axis dimension) of the lock support member 120 is typically smaller than the heights of either the key male connection member 122 or the nut coupling member 124. In some implementations, the heights of the key male connection member 122 and the nut coupling member 124 are the same. In some implementations, the height of the nut coupling member 124 is larger than the height of the key male connection member 122. The height of the nut coupling member 124 is designed to sufficiently accommodate nuts of different height and to sufficiently envelope the nut.

Some additional example dimensions will now be provided. FIG. 6 and the x-y-z axis will operate as the primary references for these examples. These example dimensions are relative to a 2″×2″ nut configuration. A person skilled in the art will appreciate how these dimensions are non-binding and are provided for example purposes only.

In one example, the outer height (e.g., along the z-axis) of the lock support member 120 is a value within a range spanning from about 1.0″ to about 2.5″. In some scenarios, that value is approximately 1.125.″ The outer width (e.g., along the y-axis) of the lock support member 120 is a value within a range spanning from about 1.0″ to about 2.0″. In some scenarios, that value is approximately 1.5.″

The outer height of the key male connection member 122 is a value within a range spanning from about 1.5″ to about 2.0″. In some scenarios, the value is approximately 1.675.″ The outer width of the key male connection member 122 is a value within a range spanning from about 1.5″ to about 2.5.″ In some scenarios, the value is approximately 2.0.″

The outer height of the nut coupling member 124 is a value within a range spanning from about 1.5″ to about 2.5.″ In some scenarios, the value is approximately 1.938.″ The outer width of the nut coupling member 124 is a value within a range spanning from about 2.5″ to about 3.5″. In some scenarios, the value is approximately 2.75.″

The diameter of the lock pin hole 126A is a value within a range spanning from about 0.2″ to about 1.0″. In some scenarios, the value is approximately 0.321.″

With reference to FIG. 16, the diameter of the opening 132 is a value within a range spanning from about 1.0″ to about 2.0″. In some scenarios, the value is approximately 1.25.″

With continued reference to FIG. 16, the value of dimension 130B is a value within a range spanning from about 0.1″ to about 1.0″. In some scenarios, the value is approximately 0.226.″ The value of dimension 130C is a value within a range spanning from about 0.1″ to about 1.0″. In some scenarios, the value is approximately 0.308.″

With respect to FIG. 15, the length of the step of the key male connection member 122 (i.e. starting from the right-most side of the lock support member 120 to the right-most edge of the key male connection member 122) is a value within a range spanning from about 0.1″ to about 1.0″. In some scenarios, the value is approximately 0.25.″

The length of the step of the nut coupling member 124 (i.e. starting from the right-most side of the key male connection member 122 to the right-most edge of the nut coupling member 124) is a value within a range spanning from about 0.1″ to about 1.0″. In some scenarios, the value is approximately 0.345.″ The smallest distance from the edge of the opening 132 to the outermost side of the lock support member 120 is a value within a range spanning from about 0.05″ to about 0.5″. In some scenarios, the value is approximately 0.105.″

Regarding the position of the lock pin hole 126A, it is preferable to position the lock pin hole 126A closer to the topmost region of the tool 118 as opposed to closer to the key male connection member 122. Notably, the primary (and perhaps only) force acting on the lock pin hole 126A will be that of gravity. That is, no torque will be applied to the lock support member 120 or to the lock pin disposed within the lock pin hole(s). Inasmuch as the lock support member 120 is inserted into the gate valve key 106 and will be visible through the space 112, it is desirable that the lock pin hole 126A be relatively closer to the top of the tool 118 as opposed to being closer to the key male connection member 122. By implementing this position, the tool 118 can likely be equipped with different types of gate valve keys, particularly ones whose spaces (e.g., space 112) might have different configurations. Also, with having four lock pin holes, the tool 118 is agnostic in terms of insertion position relative to the gate valve key 106.

The wall thickness of the walls of the key male connection member 122 are designed to be suitably thick so as to sustain strong torque forces that may be applied thereto. The walls of the nut coupling member 124 are designed in a similar manner. The thickness of the walls of the key male connection member 122 is a value within a range spanning from about 0.1″ to about 0.75″. In some scenarios, the value is approximately between about 0.125″ and about 0.375.″ In some scenarios, the value is about 0.125.″ Similar values can be used for the walls of the nut coupling member 124, although the wall thicknesses of the nut coupling member 124 will vary at different locations due to the teeth 130.

The examples shown herein illustrate how the tool 118 is axially symmetrical. That is, inasmuch as there are four different sides to the tool 118, the tool 118 is axially symmetrical if cut along the middle portion of each side extending along the z-axis direction.

Currently, the figures show the shape of the lock support member 120 as being a rounded edge square, or rather a rectangular prism with rounded edges. Other shapes can be used for this portion, however. For instance, the shape of the lock support member 120 can optionally be circular.

The shapes of the key male connection member 122 and the nut coupling member 124 will typically be square or square-like, such as a rounded corner square, or rather a rounded corner rectangular prism. The circular or cylindrical shape of the opening 132 and potentially that of the lock support member 120 can improve the ease of the manufacturing process.

With reference to FIG. 10, the lock support member 120 is shown as including four faces, with each face housing one of the lock pin holes. For instance, a first face houses the lock pin hole 126A, a second face houses the lock pin hole 126B, and so on. Some embodiments configure the lock support member 120 to include only a single face, resulting in the presence of only one of the lock pin holes. Some embodiments configure the lock support member 120 to include only two faces, resulting in the presence of only two of the lock pin holes. Some embodiments include only three faces; other embodiments include all four faces.

The material that tool 118 is made of can be made of any hard material that is durable enough to sustain a strong rotational force, such as a force sufficient to rotate a gate valve nut. The nut on the gave valve is often made of cast iron, which has a hardness rating of 40-97 on the Rockwell B scale (or 11-65 on the Rockwell C scale). In most scenarios, the material forming the tool 118 is made of a material having a hardness rating that equals or exceeds the hardness rating of the nut. Examples of such material include various different metals, including chromoly, stainless steel, iron, and so on. In some rare scenarios, other materials can be used for the tool 118, such as potentially hard plastic, ceramic, and potentially even some hard rubber material, though such scenarios are rare. Typically, tool 118 is made of metal.

Accordingly, some embodiments disclosed herein are directed to a tool that operates as an attachment to a gate valve key. This tool includes a lock support member comprising a lock pin hole through which a lock pin is placeable to secure the tool to the gate valve key. The lock support member is coupled to a key male connection member.

The tool further includes the key male connection member, which has a first form approximating that of a first rectangular prism. The key male connection member is coupled to a nut coupling member. The tool further includes the nut coupling member, which has a second form approximating that of a second rectangular prism.

A first width of the key male connection member is smaller than a second width of the nut coupling member, resulting in a step being formed at a location where the key male connection member couples to the nut coupling member. The nut coupling member includes an opening structured to receive a nut.

The opening of the nut coupling member includes a plurality of tapered teeth extending along a majority of a height of the nut coupling member. The plurality of tapered teeth taper inwardly towards a central axial axis of the tool. Also, the plurality of tapered teeth form a boundary for the opening and are arranged in a rounded square-like pattern if viewed from a bottom-looking-up perspective of the tool.

In some embodiments, the lock support member has a third form approximating that of a third rectangular prism such that the lock support member includes four different faces. Here, each face of the four different faces includes a corresponding lock pin hole such that the lock support member includes four different lock pin holes.

In some embodiments, a third width of the lock support member is smaller than the first width of the nut coupling member, resulting in a step being formed at a second location where the lock support member couples to the key male connection member.

In some embodiments, a cylindrical opening extends throughout an entire combined height the lock support member and the key male connection member. The cylindrical opening is structured to allow debris to pass from the nut coupling member through the cylindrical opening to an area external to the tool.

In some embodiments, a number of teeth included in the plurality of teeth is a value within a range spanning from 10 teeth to 30 teeth. In some embodiments, a tapering angle of the plurality of tapered teeth is a value within a range spanning from 1 degree of tapering to 5 degrees of tapering. In some embodiments, a shape of each tooth included in the plurality of tapered teeth is a semi-circular shape.

In some embodiments, the key male connection member has rounded external corners. Optionally, the nut coupling member has rounded external corners.

In some embodiments, a rotational force is applied from the gate valve key to the key male connection member and to the nut coupling member. This applied force is not applied to the lock support member.

In some embodiments, a height of the key male connection member is a value within a range spanning from 1.5 inches to 2.0 inches. In some embodiments, a height of the nut coupling member is a value within a range spanning from 1.5 inches to 2.5 inches.

In some embodiments, the plurality of tapered teeth extend along at least 90% of the height of the nut coupling member. Optionally, a height of each tooth in the plurality of tapered teeth is at least 1 inch. Optionally, the tool is symmetric.

As another option, a cylindrical opening extends vertically in a height direction from the opening of the nut coupling member through both the key male connection member and the lock support member. As a result, the tool is hollow throughout an entire height of the tool.

Some embodiments are directed to a tool that operates as an attachment to a gate valve key. The tool includes a lock support member structured to facilitate coupling of the tool to the gate valve key. The lock support member is coupled to a key male connection member. Optionally, the lock support member has a first form approximating that of a first rectangular prism. The tool also includes the key male connection member, which has a second form approximating that of a second rectangular prism. The key male connection member is coupled to a nut coupling member. The tool further includes the nut coupling member, which has a third form approximating that of a third rectangular prism.

Optionally, a first width of the lock support member is smaller than a second width of the key male connection member, resulting in a first step being formed at a first location where the lock support member couples to the key male connection member. Similarly, the second width of the key male connection member is smaller than a third width of the nut coupling member, resulting in a second step being formed at a location where the key male connection member couples to the nut coupling member.

The nut coupling member includes an opening structured to receive a nut. The opening of the nut coupling member includes a plurality of tapered teeth extending along a majority of a height of the nut coupling member. The plurality of tapered teeth taper inwardly towards a central axial axis of the tool. The plurality of tapered teeth form a boundary for the opening and are arranged in a rounded square-like pattern if viewed from a bottom-looking-up perspective of the tool.

In some embodiments, a height of the plurality of tapered teeth is at least 1.5 inches. In some embodiments, a size of the first step is a value within a range spanning from 0.1 inches to 0.3 inches. In some embodiments, a size of the second step is a value within a range spanning from 0.2 inches to 0.4 inches.

Some embodiments are generally directed to a tool that includes a lock support member, a key male connection member that is coupled to the lock support member, and a nut coupling member that is coupled to the key male connection member.

The nut coupling member includes an opening structured to receive a nut, and the opening of the nut coupling member includes a plurality of tapered teeth extending along a majority of a height of the nut coupling member. The plurality of tapered teeth form a boundary for the opening. The plurality of tapered teeth taper inwardly towards a central axial axis of the tool, and the plurality of tapered teeth are arranged in a rounded square-like pattern if viewed from a bottom-looking-up perspective of the tool.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A tool that operates as an attachment to a gate valve key, said tool comprising:
a lock support member comprising a lock pin hole through which a lock pin is placeable to secure the tool to the gate valve key, the lock support member being coupled to a key male connection member,
the key male connection member, which has a first form approximating that of a first rectangular prism, the key male connection member being coupled to a nut coupling member; and
the nut coupling member, which has a second form approximating that of a second rectangular prism,
wherein:
a first width of the key male connection member is smaller than a second width of the nut coupling member, resulting in a step being formed at a location where the key male connection member couples to the nut coupling member,
the nut coupling member includes an opening structured to receive a nut,
the opening of the nut coupling member includes a plurality of tapered teeth extending along a majority of a height of the nut coupling member, the plurality of tapered teeth tapering inwardly towards a central axial axis of the tool, and
the plurality of tapered teeth form a boundary for the opening and are arranged in a rounded square-like pattern if viewed from a bottom-looking-up perspective of the tool.

2. The tool of claim 1, wherein the lock support member has a third form approximating that of a third rectangular prism such that the lock support member includes four different faces, and wherein each face of the four different faces includes a corresponding lock pin hole such that the lock support member includes four different lock pin holes.

3. The tool of claim 2, wherein a third width of the lock support member is smaller than the first width of the nut coupling member, resulting in a step being formed at a second location where the lock support member couples to the key male connection member.

4. The tool of claim 1, wherein a cylindrical opening extends throughout an entire combined height the lock support member and the key male connection member, the cylindrical opening being structured to allow debris to pass from the nut coupling member through the cylindrical opening to an area external to the tool.

5. The tool of claim 1, wherein a number of teeth included in the plurality of teeth is a value within a range spanning from 10 teeth to 30 teeth.

6. The tool of claim 1, wherein a tapering angle of the plurality of tapered teeth is a value within a range spanning from 1 degree of tapering to 5 degrees of tapering.

7. The tool of claim 1, wherein a shape of each tooth included in the plurality of tapered teeth is a semi-circular shape.

8. The tool of claim 1, wherein the key male connection member has rounded external corners, and wherein the nut coupling member has rounded external corners.

9. The tool of claim 1, wherein a rotational force is applied from the gate valve key to the key male connection member and to the nut coupling member but is not applied to the lock support member.

10. The tool of claim 1, wherein a height of the key male connection member is a value within a range spanning from 1.5 inches to 2.0 inches.

11. The tool of claim 1, wherein a height of the nut coupling member is a value within a range spanning from 1.5 inches to 2.5 inches.

12. The tool of claim 1, wherein the plurality of tapered teeth extend along at least 90% of the height of the nut coupling member.

13. The tool of claim 1, wherein the tool is symmetric.

14. The tool of claim 1, wherein a cylindrical opening extends vertically in a height direction from the opening of the nut coupling member through both the key male connection member and the lock support member such that the tool is hollow throughout an entire height of the tool.

15. The tool of claim 1, wherein a height of each tooth in the plurality of tapered teeth is at least 1 inch.

16. A tool that operates as an attachment to a gate valve key, said tool comprising:
a lock support member structured to facilitate coupling of the tool to the gate valve key, the lock support member being coupled to a key male connection member, wherein the lock support member has a first form approximating that of a first rectangular prism;
the key male connection member, which has a second form approximating that of a second rectangular prism, the key male connection member being coupled to a nut coupling member; and
the nut coupling member, which has a third form approximating that of a third rectangular prism,
wherein:
a first width of the lock support member is smaller than a second width of the key male connection member, resulting in a first step being formed at a first location where the lock support member couples to the key male connection member,
the second width of the key male connection member is smaller than a third width of the nut coupling member, resulting in a second step being formed at a location where the key male connection member couples to the nut coupling member,
the nut coupling member includes an opening structured to receive a nut;
the opening of the nut coupling member includes a plurality of tapered teeth extending along a majority of a height of the nut coupling member, the plurality of tapered teeth tapering inwardly towards a central axial axis of the tool, and
the plurality of tapered teeth form a boundary for the opening and are arranged in a rounded square-like pattern if viewed from a bottom-looking-up perspective of the tool.

17. The tool of claim 16, wherein a height of the plurality of tapered teeth is at least 1.5 inches.

18. The tool of claim 16, wherein a size of the first step is a value within a range spanning from 0.1 inches to 0.3 inches, wherein a size of the second step is a value within a range spanning from 0.2 inches to 0.4 inches.

19. The tool of claim 16, wherein the plurality of teeth have a spiral configuration along the height of the nut coupling member.

20. A tool comprising:
a lock support member;
a key male connection member that is coupled to the lock support member; and
a nut coupling member that is coupled to the key male connection member,
wherein:
the nut coupling member includes an opening structured to receive a nut;
the opening of the nut coupling member includes a plurality of tapered teeth extending along a majority of a height of the nut coupling member,
the plurality of tapered teeth form a boundary for the opening,
the plurality of tapered teeth taper inwardly towards a central axial axis of the tool, and
the plurality of tapered teeth are arranged in a rounded square-like pattern if viewed from a bottom-looking-up perspective of the tool.
